(19) United States
(12) Patent Application Publication
(10) Pub. No.: US 2017/0297045 A1
(43) Pub. Date: Oct. 19, 2017

(54) SYSTEM FOR REGULATING THE POWER SUPPLY FOR THE MOTOR OF AN AIRLESS PAINT SPRAY PUMP

(71) Applicant: TRITECH INDUSTRIES, INC., UNION, NJ (US)

(72) Inventor: Troy ANDERSON, BLACKSBURG, VA (US)

(73) Assignee: TRITECH INDUSTRIES, INC., UNION, NJ (US)

(21) Appl. No.: 15/097,338

(22) Filed: Apr. 13, 2016

(51) Int. Cl. B05B 9/04; H02M 7/217; B05B 12/08; H02M 1/12; H02P 7/298; H02P 7/292

(52) U.S. Cl. CPC B05B 9/0413; H02P 7/298; H02P 7/292; B05B 12/087; H02M 1/12; H02M 7/217

(57) ABSTRACT

A system for regulating the power supply of the electric, motor incorporated in an airless paint spray unit so as to enhance the efficiency and performance of the airless paint spray unit. The system includes the utilization in the rector control for the electric motor driving the pump of the airless paint spray unit of an active Power Factor Correction (PFC) switching power supply adapted to regulate the electrical power supplied to the motor.

### FIELD OF THE INVENTION

The present invention relates generally to a system tor regulating the power supply for the motor of an airless paint spray pump adapted to pressurize paint so as to permit the paint to be atomized by a spray gun suitable for spray painting. More specifically, the present invention relates to such a system which employs an active Power Factor Correction (PFC) pump Switching power supply for regulating the electrical power supplied to a motor for driving such an airless paint spray pump.

### BACKGROUND OF THE INVENTION

In hydraulic or airless paint spraying, a pump is utilized to pressurize the liquid paint to pressures high enough to permit the paint to be atomized upon release from the nozzle of a spray gun. The type of pump preferably used for this purpose is the double acting piston pump because of the piston pump's ability to handle high viscosity paints or coatings easily and the capability of the double acting pump to pump fluid on both the upstroke and the downs broke of the piston thereby providing relatively even flow of paint to the nozzle of the spray gun. An example of such a pump is disclosed in U.S. Patent Publication No. 20160069344, the disclosure of which is herein incorporated by reference.

Such high pressure paint pumps are generally driven by brushed permanent magnet direct current (PMDC) electric motors operating on normal residential or commercial 120 or 240 volt alternating current service utilizing a rectified/filtered power supply. The electric drive motor and pump are combined together in a unit wherein the motor drive shaft drives the pump through a reduction gear and crank shaft housed in a gear box of the unit.

Manufacturers of such airless paint spray units have sought ways to enhance the performance of such units so as to increase the output thereof and allow more paint to be applied by users through the use of additional spray guns connected to the individual sprayer units or the use of larger nozzles or spray tips with the spray guns. One such method of enhancing performance substitutes brushless permanent magnet DC motors for the more commonly used brushed permanent magnet DC motors which thus results in a 3% to 8% increase in pump output. However, this increased performance comes with an increased cost of the motor control for such brushless motors due to the more complex circuitry required. Another method integrates a current limiting feature in the sprayer unit's motor control which allows the user to select a 15 ampere current limit or 20 ampere current limit depending on what service is available to the user at the work site. If a 20 ampere circuit is available and the user selects the 20 ampere operating mode, the motor of the paint sprayer unit so equipped will be capable of operating at maximum performance resulting in an approximately 30% increase in performance over the 15 ampere operating mode.

### SUMMARY OF THE INVENTION

It is a primary object of the present invention to enhance the efficiency and performance of electrically powered airless paint spray units. More specifically, it is a primary object of the present invention to provide a system for regulating the power supply for the electric motor driving a high pressure airless paint pump, whether it be a brushed PMDC or brushless PMDC motor or a universal type motor, so as to significantly increase the efficiency and performance thereof. Such increased efficiency and performance will allow users of the thus improved airless paint spray units to increase the productivity of their painting operations while simultaneously decreasing the operating costs associated with powering the airless paint spray units.

The above object, as well as others which will hereinafter become apparent, is accomplished in accordance with the present invention by a system which employs in the motor control of a brushed PMDC or brushless PMDC motor or a universal motor driving a high pressure airless paint pump an active Power Factor Correction (PFC) switching power supply adapted to regulate the electrical power supplied to the motor. The use of an active PFC switching power supply allows the use of a high voltage motor and by combining the efficiency of such a power supply together with the use of a high voltage motor the result is a significant improvement in overall pump system performance over prior art systems.

### BRIEF DESCRIPTION OF THE DRAWINGS

Other objects and-features of the present invention will become apparent from the following detailed description considered in connection with the accompanying drawings. It is to be understood that the drawings are designed as an illustration only and not as a definition of the limits of the present invention.

In the drawings wherein similar reference characters denote similar elements throughout the several views:

FIG. 1 is a perspective front elevational view of an airless paint spray unit incorporating the system according to the present invention for regulating the power supply of the electric motor of the airless paint spray unit; and

FIG. 2 is a block diagram schematically illustrating the airless paint spray unit and control elements controlling the electric motor thereof according to the present invention.

### DETAILED DESCRIPTION OF THE INVENTION

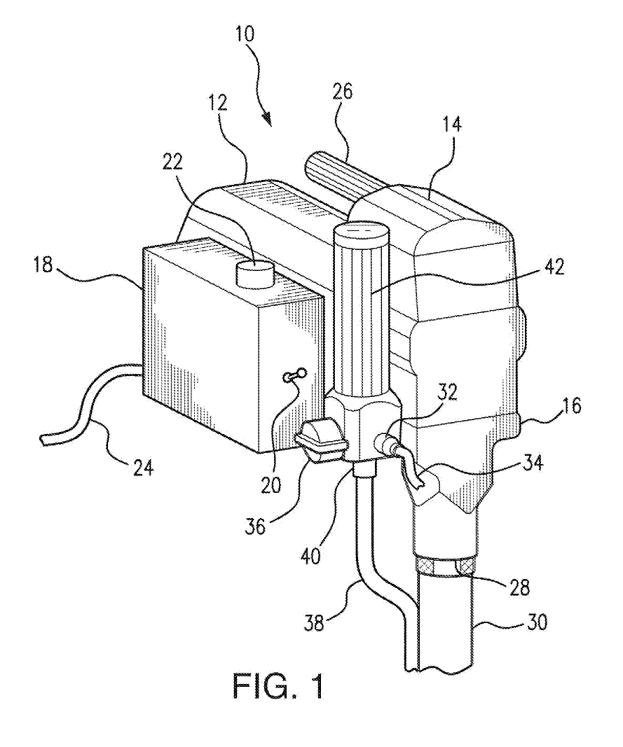

Turning now to the drawings, there is shown in FIG. 1 an airless paint spray unit, generally designated 10, including a motor section 12, a gear box 14 and a pump section 16. Motor section 12 houses an electric motor whose drive shaft drives the reciprocating piston of the pump of pump section 16 through a reduction gear and crank shaft housed in gear box 14. Motor control elements are housed in control box 18 and control the operation of the electric motor of motor section 12 through on/off switch 20 and pressure control knob 22. A power cord 24 supplies electrical power to the control elements of control box 18 and thus to the electric motor of the paint spray unit. A handle, designated 26, is provided at the top of gear box 14 to aid in lifting and carrying paint spray unit 10. The inlet 28 of pump section 16 is connected by means of down tube 30 to a reservoir (not shown) of paint such as a bucket or container of paint. The outlet 32 of pump section 16 communicates via a high pressure hose 34 with a spray gun (not shown) having a spray nozzle or a spray tip which atomizes the high pressure paint suitable for painting. A pressure relief valve located in pump section 16 is controlled by knob 36 and permits the dumping or releasing of pressurized paint contained in the pump section upon shut down. The released paint is returned to the paint reservoir via tube 38 connected to relief valve outlet 40. A filter (not shown) is housed in removable filter housing 42 adjacent to pump outlet 32 so as to filter the paint pressurized by the pump as it leaves pump section 16.

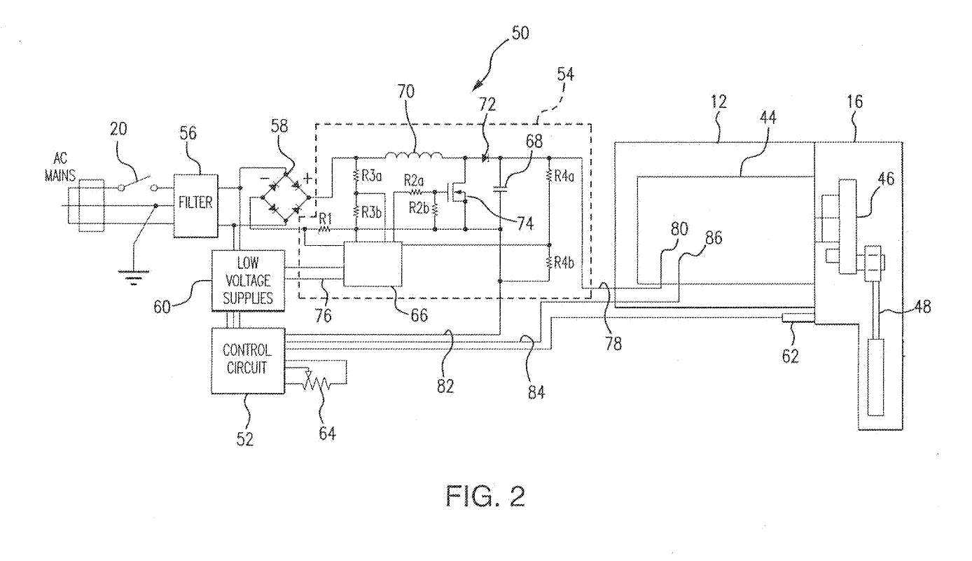

FIG. 2 is a block diagram schematically illustrating the airless paint spray unit shown in FIG. 1 and the control elements controlling the electric motor, designated 44, housed in motor section 12 of airless paint spray unit 10. As described above, the drive shaft of motor 44 through a reduction gear and crank shaft, generally designated 46, drives the reciprocating piston 48 of the pump contained in pump section 16 of paint spray unit 10. The motor control elements, generally designated 50, are housed in control box 18 of paint spray unit 10 and include a microprocessor motor controller 52, a power supply 54, on/off switch 20, EMI filter 56 for reducing electrical noise feedback into the power line, and full-wave bridge rectifier 58. Bridge rectifier 58 is connected at its input terminals to the AC power mains through on/off switch 20 and EMI filter 56 and converts the input AC power to direct current (DC) power which can be utilized to power electric motor 44. The output terminals of bridge rectifier 58 include a positive output terminal and a negative output terminal.

Microprocessor motor controller 52 may be any suitable data processing device capable of being programmed to accept input signals, compare the input signals with predetermined threshold levels and/or manipulate the input signals or comparison data as required, and output various control signals in response to the input signals and/or signal manipulations or comparisons. An example of a suitable microprocessor is PIC16F1828 manufactured by Microchip Technology Inc. of Chandler, Ariz. Microprocessor 52 is powered by the AC mains through EMI filter 56 and low voltage supplies 60 and is connected to a pressure sensor 62 which senses the output pressure of pump section 16 of paint spray unit 10, An adjustable potentiometer 64 is connected to microprocessor 52 and sets the operating pressure of the pump by means of control knob 22 (see FIG. 1). Microprocessor 52 reads the pump output pressure from sensor 62 and the operating pressure set by potentiometer 64, compares the two readings and regulates the power supplied to motor 44 as required to maintain the pump output pressure at the set operating pressure.

Power supply 54 includes Power Factor Correction (PFC) controller 66, filter capacitor 68, and PFC controller peripheral components including PFC inductor 70, PFC fly back diode 72, and PFC switching transistor 74. PFC controller 66 is powered by low voltage supplies 60 through line connections 76. PFC controller 66 utilizes resistor R1 for current sensing so as to control the current of PFC inductor 70. Resistors R2a and R2b control. PFC switching transistor 74. Resistors R3a and R3b are an AC input feedback to PFC controller 66 for sensing the AC input voltage while resistors R4a and R4b are a DC output feedback to PFC controller 66 for sensing the DC output voltage. Line 78 from power supply 54 connects the positive leg of the power supply to the positive terminal 80 of electric motor 44 and line 82 from power supply 54 connects the negative leg of the power supply to a control switch in microprocessor 52 which is then connected via line 84 to the negative terminal 86 of electric motor 44 to control power to the motor.

PFC controller 66 is preferably an active Power Factor Correction controller utilizing boost topology operating in Continuous Conduction Mode (CCM). A suitable Continuous Conduction Mode active PFC controller is the UCC28019A manufactured by Texas Instruments Incorporated of Dallas, Tex. Using a PFC controller as the power supply reduces power line harmonics and improves powerline efficiency resulting in more usable current being available to operate the motor. In addition, because of the boost topology of the Continuous Conduction Mode active PFC controller, the power supply functions as a switching regulator so that the output DC voltage can be regulated and thus permit the use of a high voltage electric motor. In the case of the Texas Instruments UCC28019 A controller with 120 volt AC input, the output can be regulated anywhere up to 380 volts DC.

As a demonstration of the improved efficiency and enhanced performance of electrically powered airless paint spray units employing the present invention a comparison was made between an airless paint spray unit operated with a standard rectified/filtered power supply and one employing a Continuous Conductive Mode active PFC controller for the power supply with both units utilizing brushed PMDC motors. Both units were operated off 120 volt AC power mains at identical or nearly identical operating currents with identically sized spray tips or nozzles attached to the respective spray guns. Since the output of a rectified/filtered 120 volt AC power supply runs at about 155 volts DC, a low voltage (155 volt) brushed. PMDC motor was used in conjunction with the rectified/filtered power supply. With respect to the CCM active PFC controller, the supply voltage was set at 360 volts DC so that a high voltage (360 volt DC) brushed PMDC motor was used. The result of this comparison test showed that the unit operating with the CCM active PFC controller had about a 25% greater pump output pressure than the unit operating with the rectified/filtered power supply at comparable power consumption. This higher performance can be attributed to how the current is drawn from the AC power mains by the CCM active PFC controller and the operating of a high voltage motor. Similar results can be expected when comparing airless paint spray units utilizing brushless PMDC motors and those utilizing universal motors. Thus, an airless paint spray unit with a CCM active PFC controller power supply operating with a 360 volt brushed PMDC motor off a 120 volt AC power source with a 15 ampere circuit will deliver substantially the same performance as a prior art unit operated with the standard rectified/filtered power supply operating with a 155 volt brushed PMDC motor off a 120 volt AC power source with a 20 ampere circuit.

In addition to the above described approximately 25% increased performance at comparable AC input currents resulting from the use of a CCM active PFC power supply versus a rectified/filtered power supply, power losses associated with the respective motors used with the two power supplies are greater with the motor of the rectified/filtered power supply than the higher voltage motor of the CCM active PFC power supply. Such motor power losses are dissipated as heat which can have an adverse effect on motor brush life, commutator life, and armature winding insulation. Thus, motors operated with rectified/filtered power supplies require greater maintenance and have a shorter useful life than motors operated with CCM active PFC power supplies. This motor power loss factor can be easily demonstrated with the following example: A 155 volt DC motor operating with a rectified/filtered power supply from a 120 volt AC power source has a resistance of 2.28 ohms, whereas a 360 volt DC motor operating with a 360 volt DC PFC power supply from a 120 volt AC power source has a resistance of 6.98 ohms. With both motors operating at the same shaft torque and speed and providing 2 horse power (HP) to the shaft, the operating current is determined by the power divided by voltage. Two horse power is equivalent to 1492 watts so that:
for the 155 VDC motor operating from a rectified/filter power supply−1492/155=9.63 amps;
for the 360 VDC motor operating from a PFC power supply−1492/360=4.14 amps.

The power loss for each motor is I²R:
for the 155 VDC motor−(9.63)²×2.28=211.4 watts;
for the 360 VDC motor−(4.14)²×6.98=119.6 watts.

Thus, it can be seen that the motor power loss for the 155 volt DC motor operating from a rectified/filtered power supply is 91.7 watts greater than the loss for the 360 volt DC motor operating from a CCM active PFC power supply.

Although the above described demonstration of increased performance and example of reduced calculated motor power loss for the paint spray units operating from a CCM active PFC power supply versus a rectified/filtered power supply were based on a 120 volt AC power source, similar but not as dramatic results are obtainable with a 240 volt AC power source.

While only a single embodiment of the present invention has been shown and described, it will be obvious that many changes and modification may be made thereto without departing from the spirit and scope of the invention.

What is claimed is:

1. In an electrically powered airless paint spray unit powered by alternating current (AC) mains including a reciprocating piston pump adapted to pump liquid paint to a pressure sufficient to allow the paint to be hydraulically atomized suitable for spray painting upon release from a spray tip of a spray gun communicating with an outlet of said pump; an electric motor having a drive shaft geared to drive the reciprocating piston of said pump; a motor control including a manually operated on/off switch, a regulatable potentiometer for setting an operating pressure of said pump, a pressure sensor for sensing an output pressure of said pump, and means for comparing the sensed output pressure with the set operating pressure and regulating the power to said electric motor so as to conform the output pressure of said pump to the set operating pressure; an EMI filter for reducing electrical noise feedback into the AC mains; and a full-wave rectifier for rectification of the alternating current of the AC mains to output direct current (DC) power, said rectifier having input terminals communicating with said AC mains and output terminals outputting DC power; the improvement comprising a Power Factor Correction (PFC) power supply communicating with the output terminals of said rectifier, said PFC power supply being adapted to regulate the DC power supplied to said electric motor.

2. The electrically powered airless paint spray unit as defined in claim 1, wherein the improvement further comprises Power Factor Correction (PFC) power supply peripheral components including a PFC inductor, a PFC fly back diode, and a PFC switching transistor communicating with the output terminals of said rectifier.

3. The electrically powered airless paint spray unit as defined in claim 2, wherein PFC power supply is an active Power Factor Correction power supply utilizing boost topology operating in Continuous Conduction Mode.

4. The electrically powered airless paint spray unit as defined in claim 3, wherein said PFC power supply supplies regulatable direct current voltage to said electric motor.

5. The electrically powered airless paint spray unit as defined in claim 4, wherein the direct current voltage supplied to said electric motor is regulated to deliver 360 volts DC.

6. The electrically powered airless paint spray unit as defined in claim 5, wherein said electric motor is a high voltage motor.

7. The electrically powered airless paint spray unit as defined in claim 6, wherein said electric factor is a 360 volt motor.

8. The electrically powered, airless paint spray unit as defined in claim 7, wherein said electric motor is a brushed PMDC motor.

9. The electrically powered airless paint spray unit as defined in claim 7, wherein said electric motor is a brushless PMDC motor.

10. The electrically powered airless paint spray unit as defined in claim 7, wherein said electric motor is a universal motor.

11. An electrically powered airless paint spray unit powered by alternating current (AC) mains including a reciprocating piston pump adapted to pump liquid paint to a pressure sufficient to allow the paint to be hydraulically atomized suitable for spray painting upon release from a spray tip of a spray gun communicating with an outlet of said pump; an electric motor having a drive shaft geared to drive the reciprocating piston of said pump; a motor control including a manually operated on/off switch, a regulatable potentiometer for setting an operating pressure of said pump, a pressure sensor for sensing an output pressure of said pump, and means for comparing the sensed output pressure with the set operating pressure and regulating the power to said electric motor so as to conform the output pressure of said pump to the set operating pressure; an EMI filter for reducing electrical noise feedback into the AC mains; a full-wave rectifier for rectification of the alternating current of the AC mains to output direct current (DC) power, said rectifier having input terminals communicating with said AC mains and output terminals outputting DC power; and a Poser Factor Correction (PFC) power supply communicating with the output terminals of said rectifier, said PFC power supply being adapted to regulate the DC power supplied to said electric motor.

12. The electrically powered airless paint spray unit as defined in claim 11, which further comprises Power Factor Correction (PFC) power supply peripheral components including a PFC inductor, a PFC fly back diode, and a PFC switching transistor communicating with the output terminals of said rectifier.

13. The electrically powered airless paint spray unit as defined in claim 12, wherein said PFC power supply is an active Power Factor Correction power supply utilizing boost topology operating in Continuous Conduction Mode.

14. The electrically powered airless paint spray unit as defined in claim 13, wherein said PFC power supply supplies regulatable direct current voltage to said electric motor.

15. The electrically powered airless paint spray unit as defined in claim 14, wherein the direct current voltage supplied to said electric motor is regulated to deliver 360 volts DC.

16. The electrically powered airless paint spray unit as defined in claim 15, wherein said electric motor is a high voltage motor.

17. The electrically powered airless paint spray unit as defined in claim 16, wherein said electric motor is a 360 volt motor.

18. The electrically powered airless paint spray unit as defined in claim 17, wherein said electric motor is a brushed PMDC motor.

19. The electrically powered airless paint spray unit as defined in claim 17, wherein sad electric motor is a brushless PMDC motor.

20. The electrically powered airless paint spray unit as defined in claim 17, wherein said electric motor is a universal motor.
